(19) United States
(12) Patent Application Publication
(10) Pub. No.: US 2007/0296575 A1
(43) Pub. Date: Dec. 27, 2007

(54) Disaster alert device, system and method

(75) Inventors: Douglas C. Eisold, San Diego, CA (US); Brent Perkins, Oceanside, CA (US); Paul A. Johnson, El Cajon, CA (US); Paul Fairchild, San Diego, CA (US); Keneth Y. Tang, Alpine, CA (US); Todd Barrett, San Diego, CA (US)

Correspondence Address: TREX ENTERPRISES CORP., 10455 PACIFIC COURT, SAN DIEGO, CA, 92121, US

(73) Assignee: TREX ENTERPRISES CORP.

(21) Appl. No.: 11/796,247

(22) Filed: Apr. 27, 2007

Related U.S. Application Data
(63) Continuation-in-part of application No. 11/473,769, filed on Jun. 23, 2006.
(60) Provisional application No. 60/900,414, filed on Feb. 8, 2007.
(60) Provisional application No. 60/904,503, filed on Mar. 2, 2007.
(60) Provisional application No. 60/795,922, filed on Apr. 29, 2006.

(51) Int. Cl. G08B 21/02

(52) U.S. Cl. 340/539.16

(57) ABSTRACT

A disaster alert system and disaster alert devices for use in the system. Each disaster alert device includes a radio receiver, and a processor programmed to monitor radio transmissions from one or more central stations for disaster alerts directed to the location of the disaster alert device. Each alert device also includes an audio unit to alert personnel located at the site of the device to the precise nature of the disaster. The disaster alert devices are pre-programmed with information identifying the precise use location of the warning device. This use location information includes latitude and longitude of the use location and may also include other location information such as street address and zip code. Warnings are broadcast from central stations identifying with latitude and longitude information specific at-risk regions to which the warnings are directed which could be, for example, nationwide, statewide, countywide, or to much smaller regions, such as several houses on a single street or even a single residence. Each disaster alert device is preferably programmed to ignore all warnings directed to at-risk regions that do not include the latitude and longitude of the use location of the device.

This invention relates to disaster alert systems and in particular to such systems for providing alerts for actual or imminent disasters such as fires, tornados, tsunamis, floods, and terrorist attacks. This application is a continuation-in-part of Ser. No. 11/473,769 filed Jun. 23, 2006 and claims the benefit of provisional applications Serial No. 60/900,414 filed Feb. 08, 2007, 60/904,503 filed Mar. 2, 2007 and 60,795,922 filed Apr. 29, 2006.

### BACKGROUND OF THE INVENTION

Disaster alert devices are well known. A disaster alert device should be capable of waking-up and otherwise alerting people to pending danger and informing the people of the nature of the danger. Since disasters are normally very few and far between, people will be reluctant to purchase or use a warning device unless it is inexpensive, requires little or no attention, and produces very few false alarms. Since a disaster may interrupt outside power sources, the device should also not rely solely on outside power.

### Fire and Smoke Detectors

Probably the most successful disaster alert device is the simple fire detector. An early fire detector invented in England by George Darby set off an alarm when a block of butter melted from the heat of the fire allowing two contacts to meet closing an electric circuit. The ionization chamber smoke detector was invented in the early 1940s in Switzerland and introduced into the U.S. in 1951. The sensitive component of the ionization detector is an ionization chamber that is open to the atmosphere. A radioactive source inside the chamber emits radiation that ionizes the air in the chamber and makes it conductive. In 1973, only 250,000 ionization type smoke detectors were sold. Most of these went to public and commercial buildings. Relatively few were installed in homes. This number increased dramatically over the next five years. In 1978, approximately 14 million ionization detectors were sold, mostly for use in homes. Over this period, the percentage of homes with smoke detectors rose from 10% to 77%. At present, over 80% of homes are believed to have one or more ionization detectors. Most ionization detectors sold today use an oxide of americium-241 (Am-241) as the radioactive source. The typical radiation activity for a modem residential ICSD is approximately 1 micro-Curie, while the activity in one used in public and commercial buildings might be as high as 50 μCi. In 1980, the average activity employed in a residential smoke detector was approximately 3 μCi, three times higher than it is today. Am-241 is an alpha emitter, but it also emits a low energy (59.5 keV) gamma ray. The Am-241 is mixed with gold and incorporated into a composite gold and silver foil sandwich. The source is 3 to 5 mm in diameter, and either crimped or welded into place inside the chamber. Optical smoke detectors are also in extensive use. These detectors include a collimated light source and a photodiode or other photoelectric sensor positioned at right angles to the beam. In the absence of smoke the beam passes in front of the detector but when visible smoke enters the beam some of the light is scattered by the smoke particles and is detected by the sensor. In a 2004 report The US National Institute of Scientific Testing reported that ionization detectors responded better to flaming fires than the optical type but that the optical type responded faster to smoldering fires. Smoke detectors are inexpensive. The lowest price ionization type detector costs about $8 and the lowest price optical detectors costs about $30.

### Available Battery Power Sources

Almost all smoke detectors contain a battery power source. For about 72 percent of these detectors batteries are the only power source. Some smoke detectors are connected to utility electric power but these detectors may have a backup battery in case the utility power is interrupted. Smoke detectors are the most common devices generally located where people live and work which are equipped with always available power sources. There are, however, many other existing devices in use which require always available power sources. These include emergency lights or emergency lighting systems in commercial and industrial buildings. Plug-in flashlights with rechargeable batteries are available and are widely used in homes for emergency lighting. Some computer systems normally connected to utility power are fitted with backup battery power. Laptop computers and many other electronic devices are equipped with rechargeable batteries. Emergency shelters are typically equipped with battery power.

### Warnings of Impending Outside Disasters

The smoke detector is an extremely valuable tool for detecting fires originating within a structure, but provides little or no warning of outside impending disasters such as approaching fires, tornados, tsunamis, floods, and terrorist attacks. Warnings of these types of disasters typically come from public sources. Some localities have public sirens that are operated when local emergency personnel become aware of weather-related events such as tornados or tsunamis. In some cases trucks with loudspeakers are used by public officials to warn of impending disasters. Warning systems such as sirens and loudspeakers are not effective for people that are too far away to hear the warning. A warning provided by loudspeakers on trucks can be delivered only to those places the truck can reach in time to deliver an effective warning.

### The NWR SAME System

The National Emergency Alert System (EAS) was established by the Federal Communication System in November of 1994. The EAS replaced the Emergency Broadcast System as a tool the President of the United States and others may use to warn the public through radio, television, and cable stations about emergency situations. Stations are required to interrupt regular programming and to broadcast the emergency information. The broadcast is directed to the audiences of the various radio and television stations with no discrimination. These warnings may be from the President if national in scope or from state and local authorities. Warnings delivered by radio or television are ineffective for people who do not at the time of the warning have their radio of television turned on. Also such warnings are typically directed to audiences much larger than necessary.

To try to provide warnings to people not watching or listening to television or radio and to try to provide some limits to the audiences, the United States Department of Commerce, the National Oceanic & Atmospheric Administration (NOAA), and the National Weather Service have developed a national weather service all hazards Specific Area Message Encoding system (referred to as NWR SAME or SAME) for delivering warnings of impending disasters via coded radio broadcasts. The coded messages identify types of dangers and attempt some identification of regions within which the danger exists. NWR refers to a series of radio stations in the United States that broadcast weather information. Today, there are 884 stations broadcasting on the NWR network covering about 97 percent of the United States population. The SAME system provides header information in broadcasts that permit automatic triggering of receiver alarms in homes for specifically defined user selected preprogrammed locales and events. A publication describing the system is available at the time of this Application on the Internet at http://www.nws.noaa.gov/directives/. In cooperation with government agencies the Consumer Electronics Association in 2003 approved standards for public alert radio and television receivers. These receivers monitor free public broadcasts from NOAA and Canadian government agency. These public alert devices can be tailored to respond to specific alerts that are broadcast by NWR or government agencies. Specific headers on the broadcasts give information about the region where the warning is directed and the type of emergency. The devices can be purchased at many commercial outlets at prices of less than $100 and can be programmed to respond to any of a list of 62 types of disasters. Headers are also programmed to indicate counties or portions of counties to which warnings are directed. Currently, the smallest area to which a warning may be directed is one-tenth of a county. (This is done with a header number, 0 to 9.) The devices are programmed to analyze the header and to ignore all warnings (within the list of 62 warnings) other than the types of warnings selected for a response and to ignore all warnings outside the area to which the warning is directed. These devices come in a wide variety of models, with many options and functions, including adjustable sirens, visual readouts, silent visual modes, chimes, and voice information. The devices are based on digital data decoding techniques, which allows alerts to be triggered through alert-capable bedside radios, home security systems, televisions, and phones. The devices provide alerts in all 50 states of the United States and some models are customized for coverage in Canada or both US and Canada. Important problems with the SAME system is that it is difficult to program the devices to receive just the warning you need without getting a lot of warnings you do not need or want. For example, the warning agency may need to send a warning into the homes of thousands or millions of people to warn only a few who may be in danger. No one likes to be woken up unnecessarily. Also, many of the devices tend to be complicated to program. In addition, evil people could transmit false alarms that could cause mass confusion. A very small percentage of the United States population currently is equipped with receivers to be able to take advantage of the SAME alert system. We need a better system.

### Prior Art Patents

U.S. Pat. No. 6,295,001 describes a tornado warning system in which National Weather Service broadcasts are monitored and filtered to identify tornado risks at particular regions. A radio alert signal is then broadcast to pager receivers programmed with the same sub-address within a region or grid block where the tornado threat was located. The pager then generates an audible signal. In one particular embodiment the pager was co-located with a smoke detector. Another prior art patent example is U.S. Pat. No. 6,084,510, in which warning devices containing GPS receivers are distributed among a large number of locations. An emergency center, upon recognition of a pending disaster, transmits via radio a warning coded with GPS information identifying the at risk region. The warning device compares its own GPS position with the identified at risk region and if they correlate the device issues a warning signal.

### Latitude and Longitude

Any location on Earth can be described by two numbers—its latitude and its longitude. If a pilot or a ship's captain wants to specify position on a map, these are the “coordinates” they would use. Actually, these are two angles, measured in degrees, “minutes of arc” and “seconds of arc.” These are denoted by the symbols (°, ′, ″ ) e.g. 35° 43′9″ means an angle of 35 degrees, 43 minutes, and 9 seconds (do not confuse this with the notation (′, ″) for feet and inches.). A degree contains 60 minutes of arc and a minute contains 60 seconds of arc.

Latitude

Imagine the Earth was a transparent sphere (actually the shape is slightly oval; because of the Earth's rotation, its equator bulges out a little). Through the transparent Earth (drawing) we can see its equatorial plane, and its middle the point is O, the center of the Earth. To specify the latitude of some point P on the surface, draw the radius OP to that point. Then the elevation angle of that point above the equator is its latitude λ northern (N) latitude if north of the equator, southern (S) latitude if south of it. On a globe of the Earth, lines of latitude are circles of different size. The longest is the equator, whose latitude is zero, while at the poles—at latitudes 90° north and 90° south the circles shrink to a point.

Longitude

On the globe, lines of constant longitude (“meridians”) extend from pole to pole. Every meridian must cross the equator. Since the equator is a circle, we can divide it, like any circle, into 360 degrees, and the longitude of a point is then the marked value of that division where its meridian meets the equator. What that value is depends of course on where we begin to count, that is, on where zero longitude is. For historical reasons, the meridian passing the old Royal Astronomical Observatory in Greenwich, England, is the one chosen as zero longitude.

### Digital Maps Showing Latitude and Longitude

Digital maps of the entire earth are available on the Internet that show latitude and longitude of any place on earth with an accuracy of a few feet. Individual houses and streets are clearly identifiable and by operating a computer mouse the latitude and longitude of any point on earth can be determined in a matter of seconds. Also, programs are available that permit a determination of latitude and longitude of any street address in the United States and many other places. Google Earth® (http://earth.google.com/) is an Internet web site that displays a Satellite image of any location in the United States and most other locations in response to the typing in a street address. The image is overlaid with latitude and longitude coordinates. For example, FIG. 8 is a black and white Google® printout of a color digital satellite image showing Longboat Way, Del Mar, California which is a cul-de-sac street, shown at 18, just west of Interstate 5, shown at 20, about 15 miles north of downtown San Diego. Portions of the image can be magnified so that objects as small as automobiles are clearly visible. Pointing a little arrow on the monitor screen using the computer mouse produces a digital display of the precise latitude and longitude of any object such as a residence that is pointed at. For example, the latitude and longitude of the residence located at 13020 Longboat Way, Del Mar Calif. is: N 32° 56′14.60″ and W 117° 14′41.48″. The accuracy of the pointer is about 0.01 to 0.10 second of arc which corresponds to about 0.3 meters to 3 meters (about 1 to 10 feet).

### Encryption

Public Key cryptography is well known in the art and involves a method of encryption and decryption of information using two numeric keys, one public and one private. The private key is kept secret and distributed to only one or few individuals. The public key is widely distributed to many individuals, and its value is publicly known. Encryption of data takes place using one of the keys, and decryption of data is performed using the other key. Knowledge of one of the keys, and the ability to use it to decrypt data does not give one the ability to derive the key used to perform the data encryption function (given sufficiently large key lengths).

### What is Needed

What is needed is a better warning system for warning of all potential disasters that is very inexpensive, that is very easy to utilize, that can be directed to regions as large as a nation or several nations or directed to regions as small as individual residences, and that can be made available to virtually every person in the country.

### SUMMARY OF THE INVENTION

The present invention provides a disaster alert system and disaster alert devices for use in the system. Each disaster alert device includes a radio receiver, and a processor programmed to monitor radio transmissions from one or more central stations for disaster alerts directed to the location of the disaster alert device. Each alert device also includes an audio unit to alert personnel located at the site of the device to the precise nature of the disaster. The disaster alert devices are pre-programmed with information identifying the precise use location of the warning device. This use location information includes latitude and longitude of the use location and may also include other location information such as street address and zip code. Warnings are broadcast from central stations identifying with latitude and longitude information specific at-risk regions to which the warnings are directed which could be, for example, nationwide, statewide, countywide, or to much smaller regions, such as several houses on a single street or even a single residence. Each disaster alert device is preferably programmed to ignore all warnings directed to at-risk regions that do not include the latitude and longitude of the use location of the device.

Preferably, to minimize required battery power the devices are programmed to sleep almost all the day and night but to wake up and listen for a warning for only very short periods of time such as one second each five minutes. The awake periods are preferably the same for all battery powered devices located in relatively large contiguous regions. The central stations that broadcast warnings are aware of the awake times, and the central stations are programmed to broadcast warnings to those devices during an awake period. Timing components in the disaster alert devices keep them synchronized with computers at the central stations. Preferably, each central station is equipped with a computer system with digital maps having latitude and longitude overlays so that at-risk regions can be specified, by personnel at a central station (or emergency personnel in contact with the central station), in terms of one or more rectangular latitude and longitude regions, or a polygon having its intersection points identified by latitude and longitude points. The computer system at the central station is preferably programmed to quickly incorporate this latitude and longitude data defining the at risk region in an information header that is broadcast by the central station along with an audio message providing a warning and instructions to people in the at-risk region. Disaster alert devices within the radio audience of the central station radio are awake during the broadcast and receive the header information. The header information is analyzed by the disaster alert devices and compared with their preprogrammed latitude and longitude positions. If they are outside the at risk region, they go back to sleep. If they are within the at risk region, they respond by recording the warning and instruction, sound an alarm, and audibly broadcast the warning and instructions.

In a preferred embodiment, mobile disaster alert devices incorporating a GPS device may be made available for mobile vehicle such as boats, cars and trucks. Each of these devices compares its actual latitude and longitude with the latitude and longitude information broadcast by the central station to determine if the device is in an at risk region. These mobile alert warning systems can also be incorporated in electronic devices that people typically carry around such as laptop computers and cell phones. These devices can get their GPS position from an incorporated GPS device or other sources.

Important advantages of the present invention over prior art alert warning systems, including the SAME system discussed in the Background section, is that warnings are in control of the emergency personnel responsible for providing the warnings. They decide when to issue a warning, the nature of the warning, and who receives it. Individuals are not required to take any action at all except to obtain a disaster alert device according to the present invention, locate it at an appropriate place, and if battery operated, replace the battery about once per year. The devices are preprogrammed with the appropriate position data by trained personnel providing the devices. No programming by the users is necessary.

Disaster alert warning devices may be distributed by mail and programmed by a computer before mailing that incorporates the appropriate latitude and longitude into the devices based on street addresses simultaneously with providing the address for mailing the device. The use location for the disaster alert device preferably is also printed on the device itself. Having control of the warning and who receives it permits emergency personnel at central offices to limit the warning to only those people within an at-risk region which can be as small as desired. The disaster alert devices can be very simple devices and mass production should cost less than $10. False alarms should be very rare. It is reasonable to expect that the devices will be utilized at least as universally as smoke detectors, both in residences and in work places. (In fact, in preferred embodiments, the disaster alert devices may be incorporated in a smoke detector or a smoke detector is incorporated in the device.) The devices may be required by public authorities or provided free of charge to persons living in some regions, such as flood plains, coastal regions subject to tsunami threats, regions near chemical plants, and regions near nuclear plants. They could also be required in new homes and public facilities such as schools. Basically, there is no good reason not to have a disaster alert device according to the present invention located where you work and where you live.

Other Possible Features of Disaster Alert Devices

1) Two-way communication feature. This communication could be limited only to responses to specific directed warnings or the two-way communication could be unlimited or other limited communication could be provided as described below.
2) All communications from the devices could include location information.
3) Systems to avoid spectrum overcrowding.
4) Base stations, fixed and mobile to control access.
5) Allocation of bandwidth techniques.
6) NWS broadcasts are retransmitted by commercial AM or FM radio stations especially in regions where there is no NWS coverage. Devices units may contain two radios or a radio that can receive both transmissions.
7) NWS broadcasts are received and retransmitted by low cost repeaters at a different frequency or low cost same-frequency repeaters.
8) Incorporation of equipment and techniques for the devices to respond with multiple languages or specific languages other than English.
9) Addition of a “help” button or similar feature so that user can transmit a help-needed signal to the location of the devices.
10) Storage and archival of a history of emergency messages for replay upon user demand.
   Other Possible System Features
1) Televisions units and commercial and public television stations and cable systems are fitted with equipment that permits television stations and cable systems or emergency personnel to turn on television units located in “at risk” regions (defined according to the present invention) to permit emergency broadcasts by the television stations.
2) Radio units and commercial and public radio stations are fitted with equipment that permits the radio stations or emergency personnel to turn on radio units located in “at risk” regions to permit emergency broadcasts by the television stations.
3) Internet providers are fitted with equipment that permits internet providers or emergency personnel to turn on computer and other devices that are connected (or are available to be connected) to the internet and located in “at risk” regions (identified according to the present invention) to permit emergency broadcasts by the internet providers to the computers and other devices

### BRIEF DESCRIPTION OF THE DRAWINGS

FIGS. 1 and 1A describe a first preferred disaster alert device.

FIG. 2 describes a disaster alert system of the present invention.

FIG. 3 describes a second preferred disaster alert device.

FIG. 4 is a map showing an at-risk region.

FIG. 5 is a magnified view of the at-risk region.

FIGS. 6 and 7 are flow diagrams showing features of a preferred embodiment.

FIG. 8 is a Google Earth map.

FIG. 9 is a block diagram of a disaster alert system using repeaters.

FIG. 10 is a drawing of a system where disaster alert units have transmitters.

FIG. 11 shows bandwidth usage in a preferred embodiment.

FIG. 12 shows frequency usage in a preferred embodiment.

### DETAILED DESCRIPTION OF PREFERRED EMBODIMENTS

### First Preferred Embodiment

### Disaster Alert Device

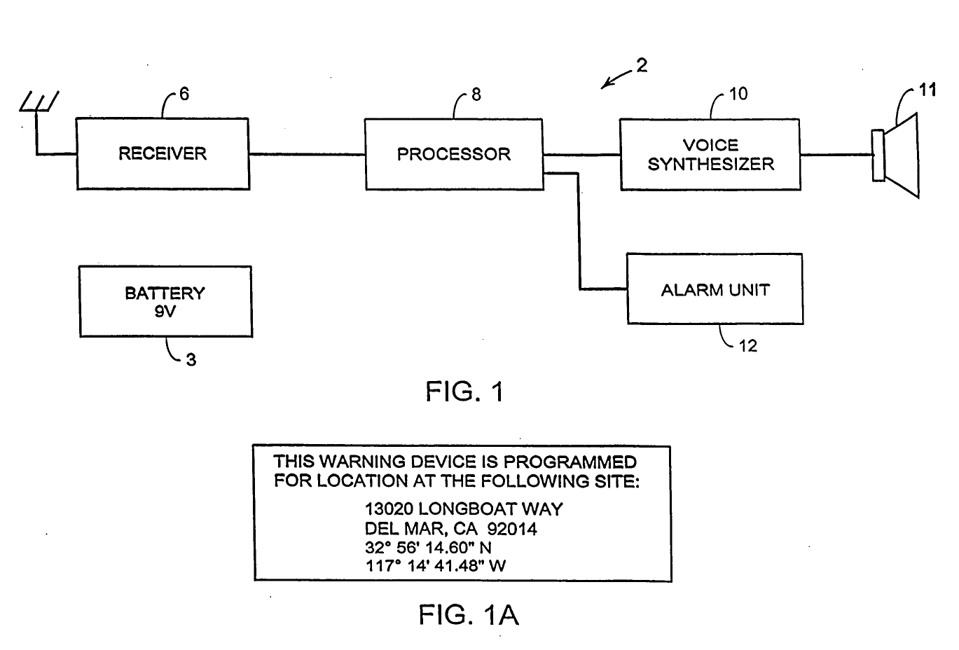

A first preferred embodiment of the present invention is described by reference to FIGS. 1 through 8. FIG. 1 and 1A shows at 2 components of a preferred disaster alert device according to the present invention. The device is battery powered with 9-volt battery 3 and also includes additional components for receiving and responding to disaster alert radio warnings. These additional components include radio receiver 6 (which may be a receiver such as Micrel Part Number MICRF007 or Analog Devices ADF7021), processor 8 (which may be a processor such as Microchip Part Number PIC18F8722 or Analog Devices “Backfin” FB525C), voice synthesizer 10 which may be a synthesizer such as RC Systems Part Number RC8650), speaker 11, and alarm unit 12. As indicated in FIG. 1A each disaster alert device preferably is programmed by the supplier of the device at the time of sale or installation with information identifying its “use location”. Like a smoke detector, no programming by the consumer is required. This use location information includes latitude and longitude of the location where the device will be installed. Latitude and longitude can also be determined using maps at the point of sale. Latitude and longitude can also easily be determined using GPS devices by sales personnel if these devices are sold door to door or by installation personnel. Also, Google Earth® web site and many other internet sites provide latitude and longitude corresponding to street addresses. The Google site provides this information for the whole earth. For devices purchased over the Internet, the latitude and longitude information preferably is programmed into the device at the same time that the user's address is printed on the shipping package. The device is labeled with a label such as that shown in FIG. 1A to remind users that the device is programmed for use at only one location. The label preferably should be placed on the device at the time it is programmed with the use location information.

A potential technique for marketing these alert warning devices is to provide the unit's use location in the form to a computer chip that is to be inserted into a slot in a radio unit that is sold at commercial retail stores such as Home Depot and Radio Shack. At the time of sale the computer chip containing the unit's use location could be ordered via the Internet from a central location, where the chip would be programmed by a computer with latitude and longitude corresponding to the mailing address of the use location. The device label would also printed by the computer. The preprogrammed chip and label would then be mailed to use location and inserted by the user into a slot in the radio unit. Assuming millions of these are to be distributed, this process of programming and mailing the chip could be completely automated.

### Central Station

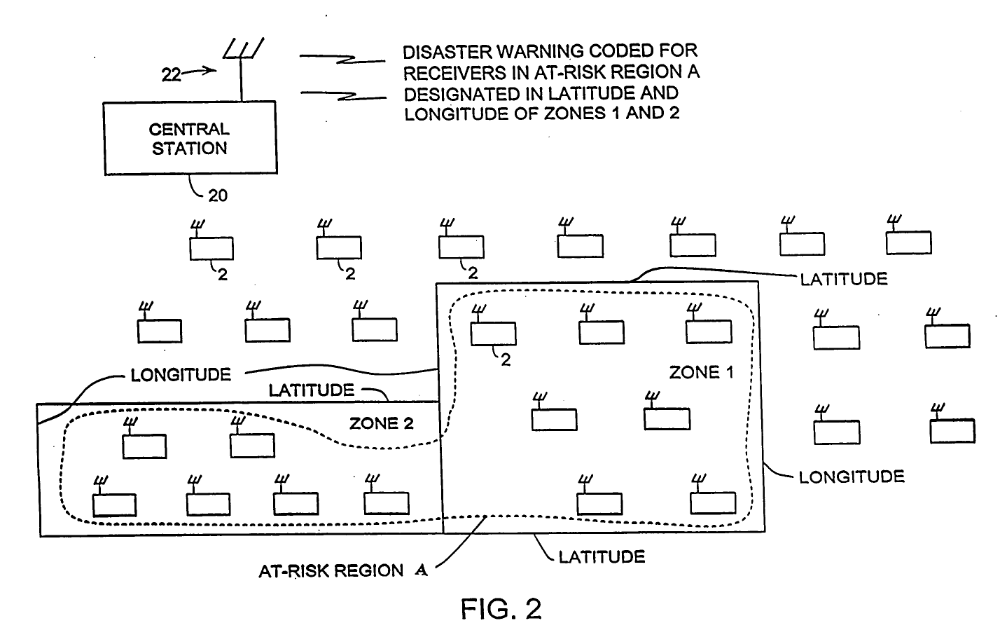

Warnings of disasters are broadcasts from one or more central stations. In the United States, central stations are preferably operated by, or under contract with, the Homeland Security Administration. Each such central station shown as 20 in FIG. 2 is preferably equipped with a transmitter 22, preferably a frequency modulated (VHF) radio transmitter operating in a frequency range (such as about 162.5 MHz) to which the radio receivers of all of the alert warning devices in the warning system are tuned. Transmissions from the central station 20 or stations may be encrypted with an encryption code recognizable by all of the alert warning devices in the system. These central stations could be operated as a part of the SAME system discussed in the Background section and utilize some of the facilities of the National Weather Radio network. Or the central station(s) could be operated independent of the SAME system.

### Identification of At-Risk Regions

Transmissions from the central station are directed to alert warning devices in specific at-risk regions. These specific at-risk regions are preferably identified by personnel such as fire officials, weather personnel, police, military, and homeland security personnel. A description of an at-risk region is conveyed to the central station. In the preferred embodiment emergency managers at the scene determine the region at risk using a mobile computing device that displays maps and other geospatial information. The computing device automatically converts the input of the emergency personnel into latitude and longitude coordinates for a set of polygon vertices. The is polygon defined so that it encompasses the entire region at risk and, as much as is possible, excludes regions not as risk. The mobile computing device can then transmit the emergency message and the definition of the at-risk region to the central station. For example the emergency manager's computing device can transmit the message to the transmitting base station using the Common Alert Protocol (CAP) and the DHS Disaster Management Interoperability Services (DMIS). Alternatively, local emergency managers can describe the at-risk region to personnel at the central station who can convert the description of the at-risk region into at-risk latitude and longitude zones. The at-risk zones in most cases will preferably envelop the at-risk region as closely as feasible. A preferred technique for doing this is to utilize digital maps which may be displayed on computer monitors such as the satellite maps available at Google Earth. As explained above, these maps may be overlaid with latitude and longitude lines with resolution of 0.1 second of arc (corresponding to about 10 feet) or less. Computers at the central station are preferably programmed to permit operators to use a computer mouse to draw on the monitor face up to ten approximately rectangular zones enveloping the at-risk region, with the borders of the rectangular zones being co-aligned with latitude and longitude 0.1 second lines. FIG. 2 is an example where an at risk region A is enveloped by rectangular zones 1 and 2 defined by latitude and longitude lines. This drawing identifies 13 receivers in zones 1 and 2 to which a warning would be transmitted.

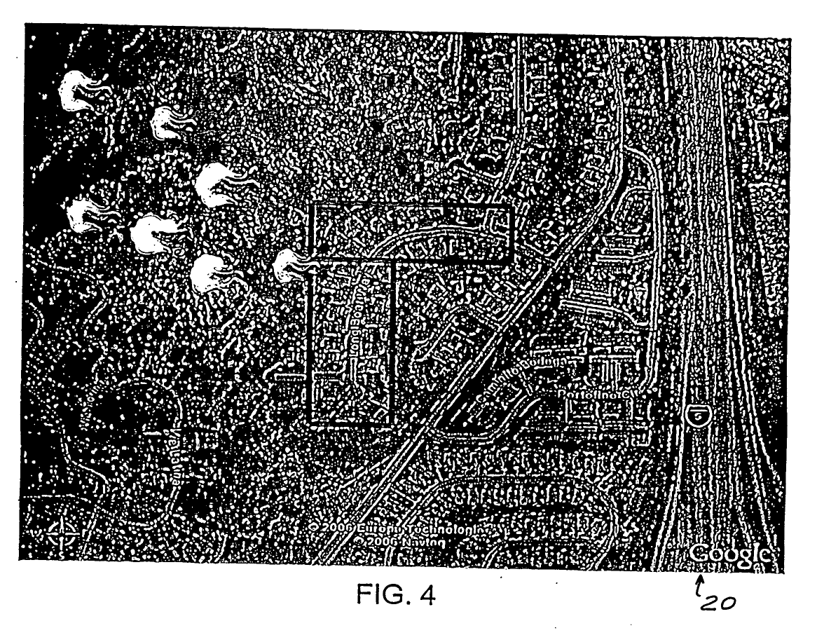

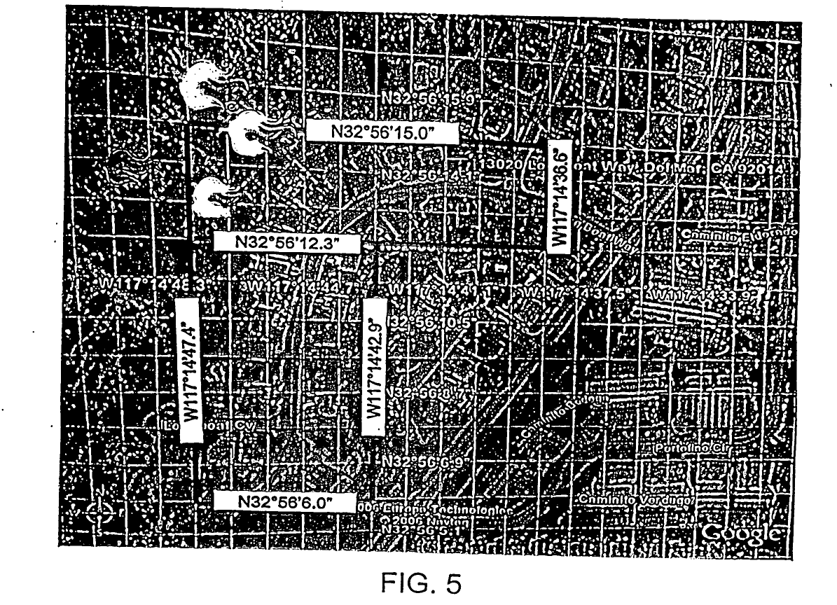

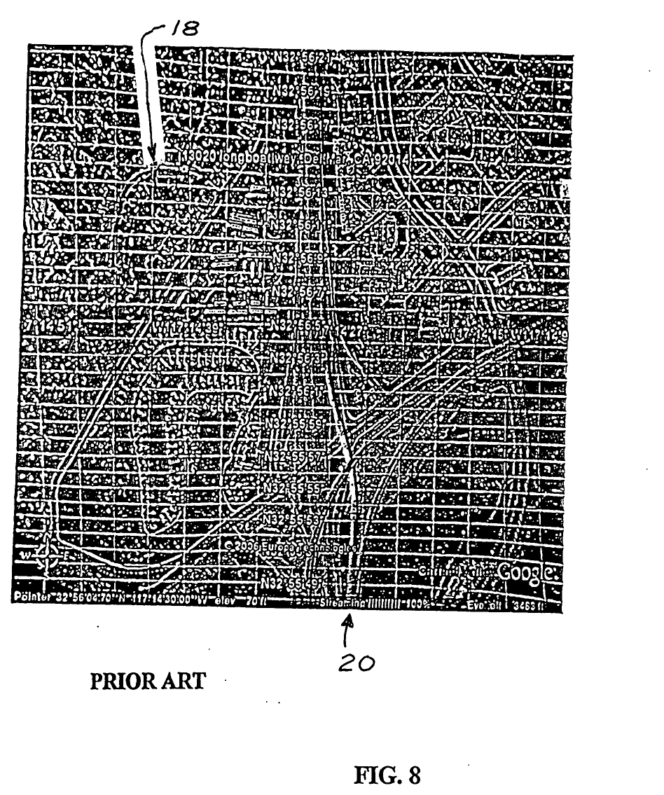

FIG. 4 is a copy of a printout of the Google Earth map shown in FIG. 8 with two rectangular zones enveloping the residences located on a cul-de-sac street, Long Boat Way, Del Mar, Calif. A forest region lies just north of Long Boat Way and a forest fire in this region could put the people living on Long Boat Way in grave danger and immediate evacuation may be necessary. A telephone call from fire officials to Homeland Security Personnel at the central station identifying Long Boat Way as an at-risk region would permit central station personnel to create two zones as shown on FIGS. 4 and 5 enveloping the 38 homes located on Long Boat Way by drawing the two rectangles as shown in the figures. FIG. 5 shows a magnified printout of a map including Long Boat Way produced using the Google Earth web site by manipulation of a computer mouse to produce the magnification. FIG. 5 shows the 6 latitude and longitude lines needed to create the two at-risk zones with the latitude and longitude lines identified to a precision of 0.1 second of arc (about 10 feet).

### The Warning and Instruction Message

Preferably, a computer processor at the central office is programmed with software that converts the latitude and longitude information of the two at-risk zones described above to digital data that can be formulated into a message header and a digital message that is transmitted to and analyzed by all of the alert warning devices located within the audience region of the central office. The warning and instruction message is preferably prepared by central office personnel and combined by the processor with the header (which contains disaster alert device wake-up information for potential at-risk regions). Central office personnel preferably are trained to respond quickly in the case of an alert like this from fire officials. Applicants estimate that these personnel should be able to prepare the message for transmission within five minutes of receipt of a legitimate alert such as the one described here.

### Programming the Alert Warning Devices

As explained above, preferred embodiments eliminate the need for any programming by the actual owner of the alert warning devices of the present invention. These devices will be rarely called upon to operate, but when they are called upon to operate their proper operation may very well be a matter of life or death. For this reason people very familiar with the device should program it and once programmed it should not be tampered with except to replace its battery when appropriate. Proper operation should be confirmed by periodic tests where test warnings with advanced notification are transmitted from the central office.

### Conserving Battery Power

In preferred embodiments, many, probably most, alert warning devices are battery operated like most smoke detectors. This allows the devices to be independent of utility power which could be rendered unavailable by the same disaster that is the subject of the warning to be communicated. Also, a battery powered unit is likely to be less costly to manufacture and less expensive to the user than a utility-wall powered unit. Digital clocks and watches can operate on less than 0.007 amp-hours per week but radio receivers require about 3 amp-hours per week if operated continuously. A typical long life battery of the type used in a smoke detector can provide about 0.5 amp-hours of electric energy, so the battery could not sustain continuous operation of a typical radio receiver for more than a few days. Applicants desire that their alert warning devices routinely operate for at least one year between battery changes. To conserve battery power, Applicants preferred battery-powered devices spend the great majority of their lives in a sleep mode, operating like a lazy clock, and consuming only about 0.007 amp hours per week. They wake up periodically to check on things and if there is no emergency they quickly go back to sleep.

To accomplish this, the devices are programmed at the factory to operate normally in sleep mode for 4:59 out of each 5:00 minutes, and to switch to radio receive mode for only about one second out of each five minutes. Preferably, a very short message will be transmitted to each alert warning device during the one second period of radio mode operation. The device will record the message and analyze it. The message will include the header created by the central station that will indicate whether or not an active warning message, for the device's general location, follows and if so will direct the unit to ‘wake-up’ and check more of the message details. If no ‘wake-up’ command is detected, the device immediately resumes the sleep mode. Each device knows its own latitude and longitude (global position) and is programmed to compare its global position to any potential ‘wake-up’ and ‘at-risk’ regions identified in the headers of messages transmitted by the central station. Typically, the message from the central station coming each five minutes will not include any directed warnings, and when it does include a directed warning, the warning will be directed to only a very small portion of the devices within the audience of the central station. When there is no warning, and for those devices that are not within the at-risk zones to which a warning is directed, the header will in effect be saying, “No problem for you and your family,” so the device then switches immediately back to sleep mode. If the device does not receive a message or if the message is other than “no problem”, the device remains awake.

If no message is received, this could mean that somehow the clock of the device and the clock at the central office transmitter are out of synchronization or that there is a problem at the central office; therefore, the device is programmed to stay awake and listen for a clock synchronization signal from the central office. Such a synchronization signal should be received within 5 minutes, at the next routine transmission from the central office. If it receives a synchronization signal, it synchronizes itself. If it does not receive a synchronization signal, it activates an indicator (such as a low power consuming LED) to alert the user that there is a ‘loss of signal’ problem and that the alert warning device is not in communication with the central office. The device preferably is programmed to beep periodically if more than eight hours pass without synchronization. The device preferably also beeps if battery voltage drops low enough to indicate its useful life is nearing its end. Specific estimates of power consumption are described below.

### Estimate of Power Consumption

Operation of the alarm receiver for one second out of every five minutes (a duty cycle of about 0.33 percent) is sufficient to provide for a greater than one-year battery life. A standard 9 Volt battery (Duracell MN1604) provides more than 500 mAH (milliamp-hours) of current (4.5 watts-hours). Devices incorporated in the alarm receiver may vary, but will have approximately the following current drain from the battery:

### Receiver and Controller

| | |
|---|---|
| RF Receiver | 3 milliamps (mA) during operation |
| (similar to Micrel MICRF007): | |
| Microcontroller | 10 mA during operation |
| (similar to Microchip | |
| PIC18F8722): | |
| Total current draw during | 13 milliamps (mA) |
| operation of receiver | |
| and controller: | |

### Wake-Up Receiver or Timer

| | |
|---|---|
| Wake-Up Receiver | 4 microamps during operation |
| (similar to Atmel ATA5282): | |
| Duty cycle timer: | 10 microamps during operation |

A duty cycle of about 0.33% means that the receiver and controller will only draw the 13 mA of current from the battery during the 0.33% of the time that it is checking for a signal from the central office. The fraction 0.33% of 13 mA is about 0.043 mA. In addition, the wake up receiver or a timer will draw about 0.004 to 0.010 mA continuously so that the total draw will normally be in the range of about 0.05 mA. If a 500 mAH battery is employed to power the receiver unit, then the battery will last approximately 500/0.05 Hours=10,000 hours, or approximately 13.9 months, a little more than one year.

### What if the Device Receives a Real Disaster Alert Warning

Only a very small percentage of the disaster alert warning devices of the present invention are expected to ever receive a real disaster alert warning. If they do however, it is very important that they respond properly. As indicated above, during each of the regular periodic one-second radio mode intervals, the device wakes up and records and analyzes the message sent to it by the central station. If the message is other than, ‘No problem for you and your family”, the device stays awake. If a warning is to be sent, the initial message will so indicate, and the message prepared by the central office will be transmitted digitally. The processor is preferably programmed to sound an alarm with alarm unit 12 as shown in FIG. 1 if called for by the message and to convert the digital voice message back a voice message that is broadcast by speaker 11. The voice message will preferably describe the nature of the warning and provide instructions as to a proper response. A specific example of such a message is provided below in a Section entitled “Disaster Example”.

### Identifying the Type of Disaster

An important improvement of the present invention over prior art warning devices is that detailed messages may be transmitted as to the particular nature of the impending disaster. Also, detailed instructions as to proper responses may be provided.

### Encryption Techniques

In preferred embodiments of the invention, messages from the central office are encrypted and a public key is used to decrypt the data sent out by the central office. Only the central office has knowledge of a private key, which is used to encrypt the data. The public key resides in each and every warning receiver that is installed in home and business. The public key will only decrypt messages that are encrypted using the corresponding private key at the central office. In this manner, the public key is used to validate the identity of the sender (the central office) and to decrypt the message. Implementations of this type are sometimes termed a digital signature due to the identity validation nature of the operation. Useful encryption techniques are described in detail in many available prior art sources. For example, a good description is provided on the Internet at www.wikipedia.org. Search for “public-key cryptography”.

In preferred embodiments of the invention, processors 8 of each disaster alert warning device 2 are programmed to ignore all transmissions at the central station transmission frequency that do not include the proper encryption code. This prevents unauthorized personnel from producing improper alarms by the disaster alarm devices. Also, the frequencies chosen for use with the present invention should be frequencies reserved for emergency radio systems so that anyone attempting to transmit improper or false warnings should be subject to criminal prosecution.

### Message Format

A typical message packet from the central office, transmitted at exactly 5-minute intervals, would be comprised of a message header, at-risk zone definitions, and a message body. Exactly every 5:00 minutes (synchronized to a standard time such as 12:00, noon, 12:05 PM, 12:10 PM etc), the alert warning device activates its radio receiver and processor controller and receives and checks for a message header from the central station, which takes less than one second. Most of the time, the message header will carry no warning and the alert warning device will resume its sleep mode. Occasionally however, the message header will include a potential risk to a “nominal” at-risk zone identified by minimum and maximum latitude and minimum and maximum longitude designations, preferably only to the nearest minute of arc, corresponding to about 6,000 feet. Initial nominal identification of at-risk regions is used to minimize the amount of information that needs to be analyzed initially by the disaster alert devices. This usually will permit most of the devices to go back to sleep without receiving and analyzing the bulk of the transmitted warnings. When warnings are transmitted, all alert warning units within the audience of the central station compare the latitude and longitude values defining the nominal at-risk region against its own latitude and longitude stored in the memory of alert warning device. If the processor determines that the device is in the nominal at-risk region, the processor extends the devices wake-up period long enough to receive the next segment of the message. The next segment of the message includes precise at-risk zone definitions, which contain latitude and longitude boundaries of up to ten approximately rectangular zones, to the nearest tenths of a second of arc corresponding. Each alert warning device in the nominal at-risk region will next use the precise at-risk zone definition information to determine whether it is inside a precise at-risk zone. If the alert warning device determines that it is inside a precise at-risk zone, then the unit will remain awake to receive, record, decode, and act on a message body that follows. If it determined that it is not in a precise at-risk zone, it goes back to sleep.

The message header transmitting the nominal at-risk zone latitude and longitude information is comprised of 64 bytes of information, and takes less than one second to receive and interpret at each alert warning device. The precise at-risk zone definitions are comprised of 256 bytes of data, for up to ten precise at-risk zones, and may take about four seconds to receive and interpret. The actual time will depend on data rates chosen. These estimates are based on a data rate of 64 bytes per second. The message body preferably is comprised of up to 18,880 bytes of information, and takes less than 295 seconds to be transmitted and received at the alert warning devices. The complete message would be comprised of:

Message Header (64 bytes total), heard by all disaster alert devices:

| | | |
|---|---|---|
| 1. | A synchronization signal: | 8 bytes; |
| 2. | Go back to sleep command (no alarms anywhere) | 2 bytes; |
| 3. | Nominal at-risk zone minimum latitude | 5 bytes; |
| | (degrees, minutes) | |
| 4. | Nominal at-risk zone maximum latitude | 5 bytes; |
| | (degrees, minutes) | |
| 5. | Nominal at-risk zone minimum Longitude | 5 bytes; |
| | (degrees, minutes) | |
| 6. | Nominal at-risk zone maximum Longitude | 5 bytes; |
| | (degrees, minutes) | |
| 7. | Other Preliminary Information, spare: | 34 bytes; |

Precise At-Risk Zone Definitions, to the nearest 0.1 second of arc (512 bytes total), heard by all disaster alert devices in the “nominal at-risk region”:

| | | |
|---|---|---|
| 1. | Min and Max Latitude and Longitude of | 40 bytes; |
| | At-Risk Zone 1: | |
| 2. | Min and Max Latitude and Longitude of | 40 bytes; |
| | At-Risk Zone 2: | |
| 3. | Min and Max Latitude and Longitude of | 40 bytes; |
| | At-Risk Zone 3: | |
| 4. | Min and Max Latitude and Longitude of | 40 bytes; |
| | At-Risk Zone 4: | |
| 5. | Min and Max Latitude and Longitude of | 40 bytes; |
| | At-Risk Zone 5: | |
| 6. | Min and Max Latitude and Longitude of | 40 bytes; |
| | At-Risk Zone 6: | |
| 7. | Min and Max Latitude and Longitude of | 40 bytes; |
| | At-Risk Zone 7: | |
| 8. | Min and Max Latitude and Longitude of | 40 bytes; |
| | At-Risk Zone 8: | |
| 9. | Min and Max Latitude and Longitude of | 40 bytes; |
| | At-Risk Zone 9: | |
| 10. | Min and Max Latitude and Longitude of | 40 bytes; |
| | At-Risk Zone 10: | |
| 11. | Other At-Risk Zone Information, spare: | 112 bytes; |

Message Text/Audio (18.880 bytes total):

| | |
|---|---|
| 1. Message Type (text, audio, other) | 2 bytes; |
| 2. Message Length that follows (in bytes) | 4 bytes; |
| 3. Message | N bytes; |

### Message Transmission

In preferred embodiments, the system operates at a frequency of approximately 108.0 MHz. Operation of the system at a frequency of 108.0 MHz allows for non-line-of-sight operation, and for some penetration through building structures. This 108.0 MHz frequency is at the edge of the standard FM radio band and a wide variety of inexpensive components are available in this frequency range. Other frequencies of operation could be used, and the choice is not that important, except for the desire to cover a large area with relatively few transmitting stations. Data can be modulated onto the carrier using several techniques, but standard frequency shift keying is commonly used. A data rate of 512 bits per second is assumed in this embodiment and provides a suitable rate for transmission of the data within a 300-second (5-minute) window. A higher data rate could be used to allow more complex messages to be sent. The one-second awake time of the alert warning devices should be ample, and in fact could probably be shortened to extend battery life.

### Disaster Example

As described above, FIGS. 4 and 5 show a hypothetical example of an impending disaster. A forest fire in the Torrey Pines Reserve in Del Mar, Calif. is bearing down on the 39 houses located on Long Boat Way as shown in the figures. If the present invention were being utilized in Southern California with a central station located for example on Mount Woodson in San Diego County, warnings could be transmitted to the people living on Long Boat Way without disturbing anyone in San Diego County other than those people.

The central station would be notified by a fire department person that persons living on Long Boat Way should be evacuated immediately since the fire in the reserve is approaching the street rapidly and could ignite the houses at the eastern end of the cul-de-sac trapping all of the residents of the street. A computer operator at the central station would locate Long Boat Way on a satellite map (such as the Google Earth map) displayed on a computer monitor as shown in FIG. 5. (The reader should note that FIGS. 4, 5 and 8 are basically black and white copies of color printouts of Google Earth's images. The color versions are much more descriptive than the black and white copies and the reader is encouraged to log on to the Google Earth web site to view the actual color images. These particular images can be located merely by inserting the Long Boat Way address provided in FIG. 1A.) The operator uses a computer mouse draws two approximately rectangular shapes on the map with the lines of the approximate rectangles corresponding to latitude and longitude lines as shown in FIGS. 4 and 5. The lines are drawn to a precision of 0.1 seconds of arc as shown in FIG. 5. The operator is able, using only two at-risk zones, to precisely define the immediate at-risk region needing to be evacuated so that an evacuation order can be transmitted to the people living on Long Boat Way without unnecessarily frightening any other persons. As soon as the operator is confident that he has the at-risk region properly identified with the two rectangles, he clicks an appropriate logo provided on the monitor and the computer automatically creates a header and part of the message for a disaster warning to be transmitted. While the computer operator is identifying the at-risk zones as described above another operator at the central station records the following voice message:
“This is an emergency warning from the San Diego Office of the Homeland Security Administration! This is not a test! There is a major forest fire currently burning in the Torrey Pines Reserve northwest of and approaching Long Boat Way. All residents occupying structures located on Long Boat Way and Long Boat Cove are instructed to evacuate immediately in an easterly direction on Long Boat Way, then proceed south on Portofino Drive to Carmel Valley Road. This is not a test, this is an actual emergency. All people should immediately begin evacuation.”

This voice message is digitized and compressed by the central station computer using mp3 (or other) techniques and combined with the portion of the message prepared by the computer operator. The operator then clicks a logo to transmit the combined message. The computer processor then transmits the message at the next one second awake window at a 5-minute interval as described above. Disaster alert devices powered by wall power are awake continuously so a message to these devices could be sent as soon as it is ready. The message to the battery powered units could be delayed up to 5 minutes.

As indicated above, the header portion of the message will designate the nominal at risk zone with the following latitude and longitude information:
N32°56′-N32°57′ and W117°14′-W117°15′.

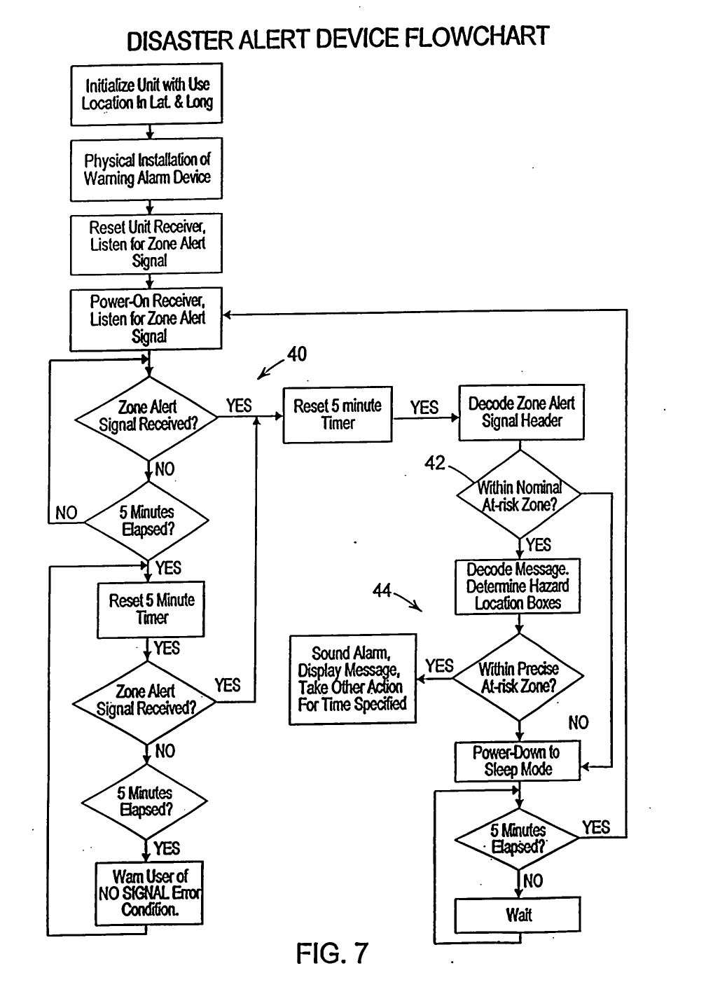

This corresponds to a region which is more than one mile square and includes much of the city of Del Mar and portions of the city of San Diego. All of the alert warning devices in the nominal at-risk region will remain awake and analyze the next portion of the message. The first part of the rest of the message more precisely defines the at risk region with the two at-risk zones shown in FIG. 7. This information is:
N32°56′06.0″-N32°56′12.3″ and W117°14′42.9″-W117°14′47.4″
N32°56′12.3″-N32°56′15.0″ and W117°14′36.6″- W117°14′47.4″

All of the alert warning devices in the homes on Long Boat Way respond to the central station transmission by initiating an alarm from an alarm unit as shown at 12 in FIG. 1A and broadcasting the voice message printed above. Alert warning devices outside the precise at-risk region will not initiate an alarm or otherwise disturb anyone.

Since this is a major fire the fire department may want a general warning to be transmitted by the central station to a larger region without an evacuation order. In this case the fire department should give the central station guidance as to the size of the larger region to be warned and a second message should be sent to people in the larger region via their alert warning devices. This message would not require evacuation but may explain that the people living on Long Boat Way have been ordered to evacuate.

### High Alert and Very High Alert Modes

As indicated in the above disaster example, the central station could be delayed up to five minutes in issuing the warning since the battery operated alert warning devices could be in their sleep modes for that period of time. To avoid this, the disaster alert devices could be provided with software that would permit the central station to put them in a high alert mode or a very high alert mode. In a preferred embodiment the high alert mode would cause the devices to wakeup at one-minute intervals (instead of five) for one second and in the very high alert mode the devices would be caused to remain awake continuously for a specified period of time, such as ten minutes or another appropriate time to prepare a specific message to be transmitted. The change of mode could be transmitted to all of the units within the audience of the central station or to any portion of its audience based on latitude and longitude designations as described above. Preferably, the central station would appropriately limit the periods of high alert or very high alert since operation in these modes greatly increases the battery drain. As explained above units powered by wall-utility power preferably are programmed to stay awake in radio receive mode continuously since the power drain is small compared to typical overall house electric power usage; however, these devices too could be programmed to take advantage of the same sleep-awake strategy proposed for the battery powered units.

### Operational Flow Charts

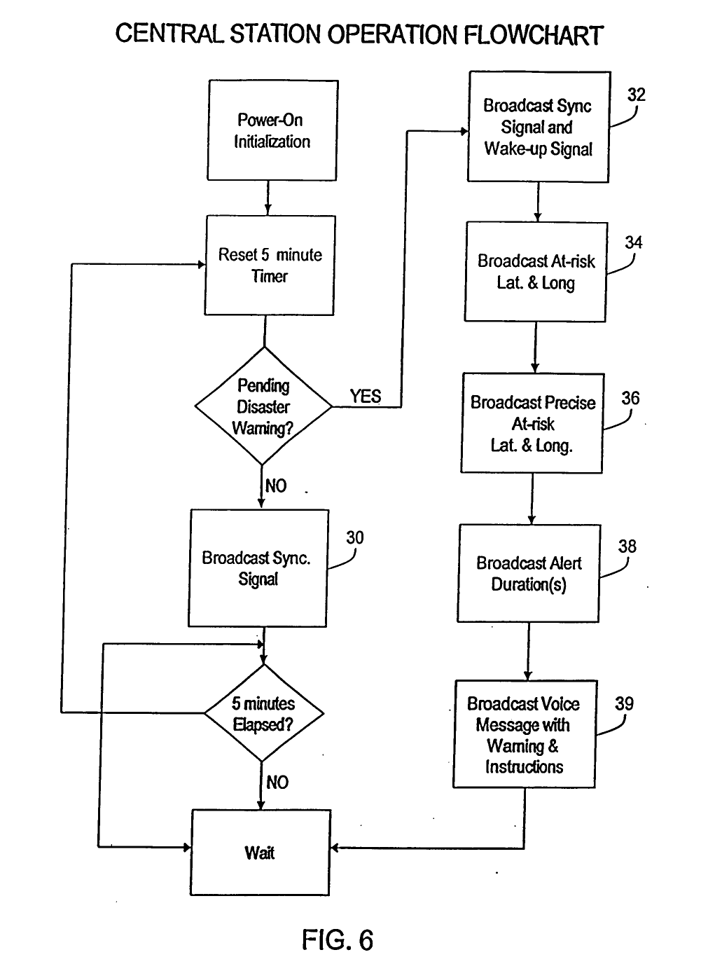

FIGS. 6 and 7 are flow charts describing how the processors at the central station and in alert warning devices may be programmed and operated in preferred embodiments of the present invention. As shown at 30 and 32 in FIG. 6 the computer processor is set up to broadcast at least a synchronization signal each five minutes to keep all battery powered alert warning devices in its audience in synchronization. If there is a pending disaster it also broadcast a wake up signal directed to a nominal at-risk region defined by nominal latitude and longitude as shown at 34. This allows the devices in the nominal at-risk region to receive and analyze the precise latitude and longitude and determine if they are within it. This typically allows most of the alert warning devices in the audience of the central to go back to sleep. The central station also broadcast the precise latitude and longitude as shown at 36, the alert duration as shown at 38 and a voice message with warning and instructions as shown at 39. The alert devices will broadcast the message for a duration specified by the central station.

FIG. 7 is a flow chart describing how the processors in the alert warning devices may be programmed and operated in preferred embodiments of the present invention. This chart also indicates as shown generally at 40 a preferred technique of one second of radio receive operation each five minutes to conserve battery power. If the processor determines from header that the alert warning device is within the nominal at-risk region as shown at 42, it decodes the rest of the message and determines if the device is in the precise at-risk region. If no, the device goes back to sleep. If yes, it sounds an alarm and broadcasts the message as instructed by the central office as indicated at 44. If it is not in the precise at-risk region the device goes back to sleep.

### Alerting Emergency Crews

The present invention can be applied by the central office to activate emergency crews. To do so the central office would program its computers with the latitude and longitude of the residences of members of various types of crews such as special police units, and special fire fighting units. These lists could be kept on a shift-by-shift basis and updated continuously so that the central station personnel would know which groups of personnel are off duty at any time. By directing a message to the disaster alert device of each crew member (by specifying their precise latitude and longitude) the central station personnel could immediately issue a request to these personnel to report to duty in case of a severe emergency.

### Prototype Device

Applicants initially constructed a rough prototype device of the present invention using parts from a remote controlled toy truck and radio receiver, both purchased off-the-shelf from Radio Shack. The toy truck transmitter and the radio receiver operated at 75 MHz. A digital voice recorder to provide prerecorded warnings activated by the transmitter was also purchased from Radio Shack. The device was incorporate with a smoke alarm was purchased from Target.

### Voice Message Alternatives

The system could be set up to transmit voice messages through a variety of alternatives. These include digital transmission of voice data that would be broadcast by the alert warning devices via a voice synthesizer. This approach is probably the most efficient in terms of bytes of data needed to transmit a specific voice message. Voice can also be transmitted digitally and converted to voice with much higher quality using well-known mp-3 techniques. Other digital audio techniques are available that could be adapted to transmit and deliver the voice message. Another approach is to have the central station transmit a signal to the alert warning devices to switch to a receive configuration that would receive an analog radio message. The alert warning devices could be preprogrammed with a variety of pre-recorded texts and warnings each of which could be activated and broadcast based on instructions for the central station.

### Alternative At-Risk Designations

The preferred means of designating at-risk regions is by determining a polygon that encloses the region at risk and defining that polygon in terms of the latitude and longitude of its vertices. There are however, alternate techniques for precisely identifying at-risk regions that could be utilized, in addition to the latitude and longitude technique, to direct a warning from the central station to the alert warning devices. Preferably these would use indicia that are associated with the location of the alert warning devices. These include address information such as Post Office ZIP codes, city and state names, and telephone area codes. This information could be programmed into the alert warning devices and the devices could be programmed to examine headers for any of these indicia for warnings directed to warning devices within the indicated regions.

### Test Signals

Preferred embodiments may provide for periodic tests to assure users that their devices are operating properly without creating disturbances for those people who do not wish to be disturbed. A preferred technique would be the transmission from the central station of a 3-second pleasing bird call at a regular periodic time such as exactly noon on every Sunday or at exactly noon on the first Sunday of each month. Users could listen for the timed transmission to gain some assurance that the warning system is in operation and that their government is watching out for them. (A web site could be set up to allow users to guess at the type of bird. Alternatively, 5 or 6 notes of famous songs could be played and users could try to “name that tune” at the web site. This would be a technique for assuring that the system is working.) Another approach would be to program the alert warning devices to turn on a low-power LED during the one-second wake-up periods. This would occur each 5 minutes and would also give some assurance that the device is in working order. The system operators could also schedule test transmissions of test warnings with proper notice in advance. The voice message would also explain that “This is a test” so as to avoid any unnecessary alarm by the device users.

### Tapping into Always Available Power Sources

As an alternative to the battery powered approach described in detail above, alert warning devices of the type described above could utilize other available electric power sources. For example, the units could be powered with wall (utility) power at 120 Volt (AC) with or without a backup battery supply. The alert warning device could be incorporated into a smoke detector and utilize its power source, whether battery, wall or wall with battery backup. A good solution for business facilities is to incorporate the disaster warning devices with emergency building lighting which typically utilizes relatively large back-up battery power sources. With plenty of electric power and no need to worry about replacing batteries, the devices could be programmed to stay in the radio receive mode continuously. Alert warning devices could be incorporated into radio or television sets and programmed to turn the set on if it is not already on for receipt of a warning via the television or radio station. Also, the alert warning device could be a part of a radio or television system that continuously broadcasts music or other desired programming which would be interrupted only when a warning is to be directed to the particular alert warning device. As above the device would be programmed to turn the television or radio on if it is off when a warning is to be broadcast.

### Mobile Units

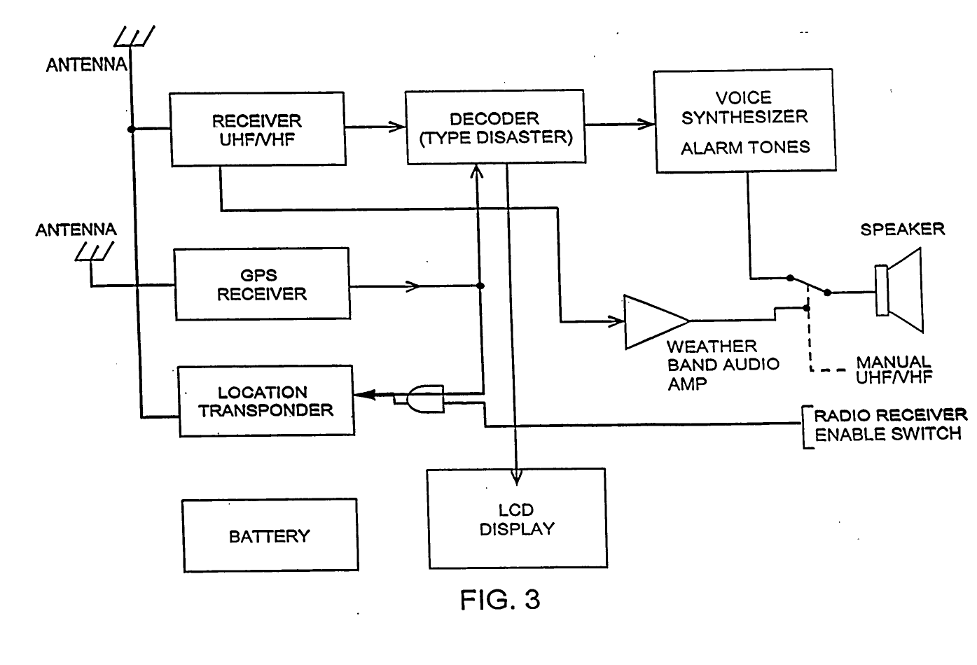

In a preferred embodiment, mobile disaster alert devices incorporating a GPS device are made available for vehicles such as automobiles, trucks and boats. These devices compare their actual latitude and longitude with the latitude and longitude information included in the header broadcast by the central station to determine if the device is in an at-risk region. These mobile alert warning systems can also be incorporated in electronic devices that people typically carry around such as laptop computers and cell phones. These devices can get their GPS position from an incorporated GPS device or other sources. FIG. 3 is a drawing showing a unit with a GPS receiver. Most of us don't walk around with our cell phone in expectation of a disaster. But the concept of a low cost free public service GPS-cell phone disaster alert system has the potential of capturing a large market share. It is a one time purchase price, install it and forget about it, but have the comfort of knowing that if you are driving and a local disaster were to happen you would be immediately notified.

Every first responder vehicle could have a GPS-phone disaster alert unit installed. These first responders include: ambulances, fire vehicles, police vehicles; city, county, and state work vehicles, electric and water utility vehicles etc.

A very sophisticated real time infrastructure is being built to supply real time traffic information to numerous user devices such as cell phone, Personal Navigation Systems, Vehicle Navigation Systems, Vehicle Telematics Systems, and Satellite Radio just to name a few. In a time of national or local emergency, traffic flow can be very critical in facilitating orderly evacuations. Preferably embodiments of the present invention would include an interface to at least one of these real time traffic and information sources. This information is already geo-coded and can be easily structured for the present invention application and redistributed by a central server to any area of disaster. The distributed data can be provided to both the EM-Toolkit and the BAR-Toolkit for review before adding to the emergency broadcast. As with other vital information this traffic information can be updated periodically as necessary and can also be useful as a local tool for local first responders. When all personnel at a particular location are evacuated together they could be instructed to take their disaster alert device with them so that the Central Station can continue to provide information and instructions. In addition the mobile devices mentioned above already know their location and with the addition of the basic alert receiver circuitry can receive the at-risk polygon and announce an alert if they are within the at risk area.

### Mobile Phones Programmed as Disaster Alert Devices

I preferred embodiments of the present invention all organizations providing mobile telephone services would be required to participate in the disaster alert system of the present invention. Modern cellular telephone systems are designed to track each user's position so that emergency operators can send aid in the event of a 911 call. This position information can be used to coordinate disaster alerts on a location-specific basis.

If the cellular base stations are made compatible with the disaster alert system of the present invention, the cellular telephone system can determine the telephone numbers of all of the telephones in their systems that are located in any at-risk region identified by emergency personnel. All of this information can be organized by computer processors and telephone messages can be transmitted to the telephones warning the users of the danger and providing instructions. In the event of a disaster in a specific area, an alert would be transmitted from the central station to the cellular telephone organization. The signal would be received at the cellular base stations operating in the affected at-risk regions, and those cellular base stations would then interpret the location information, compare that information with the phone locations in their area, and if some certain telephones are within the disaster alert area, the cellular system would automatically dial those phones and transmit appropriate warning information and instructions.

### Other Devices Programmed as Disaster Alert Devices

Many televisions users have Digital Cable and Digital Satellite Set top boxes which are connected to a network by wired cable, satellite, fiber optic and conventional telephone lines. The owners of these communication systems know the street addresses where these units are located and can easily convert these street addresses into latitude and longitude locations. These communications systems have the ability to individually address each Set Top Box and can easily download the specific latitude and longitude of the box location. In preferred embodiments electronic components can be wired into computer, television and radio units that would permit the communication companies to transmit a signal to the units turning them on (if they are off) and causing the units to broadcast a appropriate disaster alert warning. Alternately only software changes would be needed to accept the latitude and longitude information. Emergency agencies would transmit latitude and longitude at-risk polygons to the communication companies. Computers at the companies would determine which of their customers are within the at-risk regions. Then signals would be transmitted to the television, computer and radio units turning them on and broadcasting the appropriate warning and instructions. Alternately the companies would just relay the standard alert information with the latitude and longitude at-risk polygons and the set top box can determine if it is in the at-risk region and take appropriate action thus eliminating any additional burden on the company decide who may or may not be at risk.

### Extending Central Station Coverage

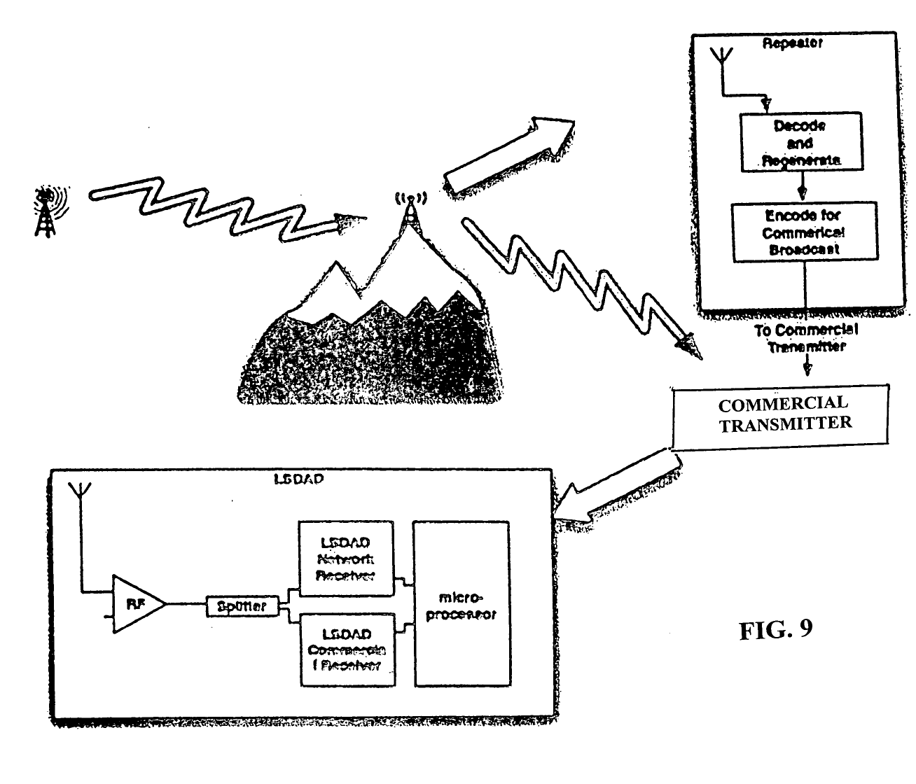

For the disaster alert system of the present invention to be very successful its advantages need to be available to as many people as feasible. This requires very broad Central Station radio coverage. If the NWS radio system is used about 97 percent of the people in the country could be covered. In places where NWS is not available, a repeater could be made which receives the NWS broadcasts regenerates the digital signal and re-encodes the signal for broadcast on a commercial AM or FM station. The disaster alert units could then be built with two receivers. The first would look for the standard signal from the national network. If it is not available a second receiver would search the commercial AM or FM radio band for a digital signal carrying the emergency transmissions. FIG. 9 shows a top-level block diagram of the system. A digital signal broadcast by the NWS transmitters is received and decoded by repeater 50. The signal is then regenerated and recoded into a second digital format compatible with digital sideband transmission on standard commercial AM or FM radio bands. The AM sideband transmission may be compatible with commercially available sideband transmitting systems such as the HD Radio system designed by iBiquity Corporation, or may be another type compatible with traditional analog FM and AM audio broadcasts. The commercial radio station then broadcasts the signal. A disaster alert unit which contains two receivers and decides which signal is the strongest. The repeaters for the commercial AM & FM stations could be placed near the AM & FM transmitter, which are typically in a region with good reception, high on a tower and/or hill. Alternatively the repeater could feed the digital signal to the radio station office which could insert the signal into their standard transmitter feed. In any case the transmission of the disaster alert signal would require little or no intervention by the commercial radio personnel.

### Adding a Transmitter to Disaster Alert Units

A natural extension of the disaster alert devices described above is integrating a transmitter into them so that the occupants at the installed location can have two-way communications with emergency responder personnel. Broadcasts of the traditional warning messages could still be conducted using the network of transmitters such as NWS radio system. These original transmitters would continue to transmit location specific alert warnings and messages, but other base-stations could be used to support two-way communication with disaster alert units.

The communications from the user to the emergency responders can take many and varied forms. The type of communication can range from a simple and limited case where the occupants are only allowed to use the transmission capability of the disaster alert unit to acknowledge the receipt of a message transmitted to it by emergency managers, all the way to two-way “full-duplex” channels similar to that existing on a public switched telephone network. Preferably in all communications the units will incorporate its internal installed location information into its transmission in order to inform the emergency management personnel of its location

The reason to consider a variety of link types instead of providing the full-duplex communication to every device is to conserve limited radio frequency communications bandwidth. Emergency situations vary, and communications needs vary likewise. In some situations only a small number of devices may be active and full duplex communications may be feasible and appropriate. In many cases where thousands of units are involved in the same region full duplex radio communications for all would be very difficult in not impossible.

There are many potential uses for two-way communication. An example is a 911 type radio call to emergency responders. An occupant may need to alert emergency personnel of a situation that they are not already aware of. Emergency responders may need to communicate with individuals at a location. Two-way communication would be useful when searching for survivors. Specific instructions may need to be provided for evacuations where it may require a disaster alert unit user cannot comply with a general evacuation order. For example, a user may need to explain that he is confined to a wheel chair. Emergency personnel may need to question users before entering a building.

It may be desirable to provide for only very limited responses via the disaster alert devices to conserve band width; for example, including in the disaster alert units a capability to answers questions with a yes or no and maybe with numbers from 0 to 9.

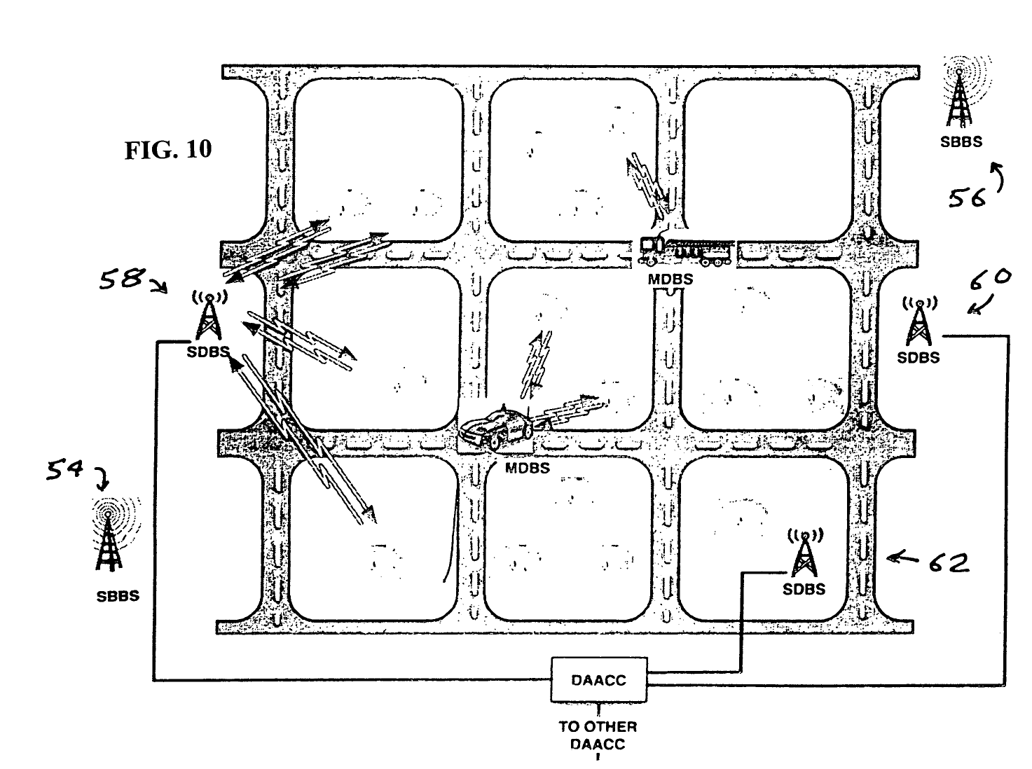

In order for two-way radio communication to work some sort of access control must be exerted in order to conserve bandwidth. Access control may be handled in many ways. For example, a peer to peer network could be established between the devices and the receiving devices and arbitration handled similar to the ways that it is handled in commercial peer-to-peer network. However, the way that appears to make the most sense is to use base-stations in the hands of the emergency responders to control access to a disaster alert transmission bandwidth. Base stations in the control of emergency responders could be set up across the region to be served. The base stations may be fixed units in towers or portable units in cars or handheld. Each base-station may use a different frequency as cell phone base-stations do, or may all use the same frequency band and some for of base-station access control. Multiple units can be given access to the broadcast bandwidth using TDMA, CDMA, OFDMA, or some other multiple access scheme, to share the available frequency space. Different bands or access space may be given to different types of communications. For example simple duplex communication may be assigned to some bands while full duplex access is assigned others. Or alternatively communications with stationary base-stations may be assigned one band and communications with mobile base-stations assigned a different bandwidth area. FIG. 10 is a schematic representation of extended portion of a disaster alert system. Two stationary broadcast base stations 54 and 56 serve the area in question. These stations broadcast the standard one-way location specific warnings and instructions to the disaster alert devices. Three stationary duplex base-stations 58, 60 and 62 serve the same area. These could reside at police stations, firehouses, or other civil defense offices. Mobile duplex base-stations can be deployed as needed in police cars, fire engines, ambulances, and other mobile and hand-held devices. Access control is required so that the various base-stations and disaster alert devices do not interfere with each other, and is maintained by a network of disaster alert access control centers.

One possible way to allocate bandwidth resources for the extended duplex communication is to use the frequency space allocated for the NWS radio. The center frequencies of the 7 analog, 25 kHz analog channels allocated to radio system would be made available. For any location one analog channel is reserved for the classical analog NWS transmissions. The rest of the frequency space is divided up into approximately 300 orthogonal frequency divisions with width of approximately 500 Hz. This frequency sharing scheme would be used in this embodiment. Other embodiments can use sharing schemes such as Time Division Multiple Access (TDMA) or Code Division Multiple Access (CDMA). Ten slots are reserved for digital simplex transmissions, and ten slots are allocated for access control and network overhead. One hundred slots are reserved for the simplex duplex communications described above and the final 180 slots are reserved for full duplex communications. The actual frequency slots allocated for any given area are cycled through available frequencies as the center frequency of the local analog NWS analog signal moves. For the example above the analog signal is at 162.475 MHz. However, depending on location the local analog signal could be at any of the standard frequencies.

Another possible way to implement the two-way communications is to utilize the 700-800 MHz band. This spectrum range is currently under consideration by the FCC for designation as an emergency use band, and is already under use by some agencies for this purpose. For example, the city of Washington D.C. is currently implementing a WiFi network at these bandwidths to provide rapid and high bandwidth communications between emergency managers, police and other emergency responders. The disaster alert devices could contain a WiFi chipset that would allow them to join such a network, and use the access control already provided by the WiFi protocol. This would leverage local infrastructure investments and allow easy access between the public and emergency personnel.

If some two-way communication is provided the present invention could be used as an alternative to the current “phone alert” device being used today. This device allows (usually the elderly) to hit a button that is worn around their neck that will call the emergency service. Disaster alert devices could have the potential to have it do the relay to a service provider that would call the emergency services when needed. The advantage would be that disaster alert devices of the present invention are “location specific” and would alert the emergency responders to the exact home location by latitude and longitude. Applicants have learned that sometimes (especially in rural areas) that the emergency services have a hard time locating a specific home.

### Short Range Wireless

Another potential addition to the basic concept of the present invention is to add a short range wireless feature to the disaster alert devices. Examples include Bluetooth and ZigBee technoogies. With these features the disaster alert devices could be programmed to turn on computers, televisions and radios whenever the devices receive a warning that they are within an at-risk region. By connecting to a computer that is connected to the Internet the device could be programmed to transmit e-mail messages to interested persons such as a family at his work location or upon alert automatically transfer vital information about the household and its occupants directly to a First Responder Database eliminating the need to make a voice call to 911 at a time when 911 voice lines are likely to be busy and unreachable

### Memory Cards and SD Cards

Disaster alert devices can be adapted to accept the insertion of special preprogrammed memory cards. For example, cards could be made available with stored foreign language dictionary type information permitting the processor of the disaster alert device to translate warnings in English into a specific language other than English. Cards could be prepared for all languages represented in a population. These cards could be inserted at the point of sale so that users are not required to do any thing except replace the battery once per year. However a procedure should be in place to test the unit to make sure it is working properly. In some cases users may have a desire to program their disaster alert device to perform special functions, especially if it has transmission capability, either long range or short range. In this case the standard disaster alert could include a feature permitting the insertion of a programmable card which can be programmed using a personal computer. It would be possible to include features allowing the warning issued by the disaster alert to be in a voice of one of the parents of a household or for the head of the household to record a specific message for each type of alert that would be played at the end of the standard alert. There is some evidence that young children are more likely to obey the voice of a parent than a strange voice. If the disaster alert device has wireless the memory card could contain the number of people in the household, sex, age, handicap status, elderly status, existing medical conditions, all which could be instantly transferred to a First Responder database on alert thus giving the an split second view of all at risk homes and occupants in the immediate area of an alert.

### Child Predators and Dangerous Person Alerts

Important uses of the present invention are to warn people in affected neighborhoods of reports of a child predator or other dangerous persons such as an escaped prisoner.

### Alert Registry

Another important aspect of the present invention is the ability of each alert device to be individually addressable. A registry could be established where individuals could register their alert device (similar to a warranty registration) so they might take advantage of personalized services. The same signal that broadcasts the digital message and at-risk polygon can also broadcast specific messages to individual alert devices or groups thereof. Examples are where only one household is at risk from a predator that violates a restraining order or a gas leak at one residence only affects 4 houses on a block.

### High Definition Television

TV broadcasters are in the process of providing HDTV capability. The distribution of HDTV broadcast stations is being planned so that there is no place in the US that will not be covered by a HDTV broadcast (most areas will have at least three overlapping signals.) HDTV transmitters are much more powerful than analog UHV/VHF transmitters. Already in development are low power chipsets capable of receiving HDTV sub carriers even in underground areas and deep building areas. With the addition of electronic circuitry by receiving the signal of three HDTV transmitters an HDTV receiver can know its latitude and longitude. HDTV transmitters could be used to broadcast the at-risk polygon and alert information and each HDTV can decide if it is in the at risk region.

### GPS Receivers

GPS receivers are used by mariners, fisherman, hikers, backpackers, mountain climbers, and skiers, for navigation and security while out of touch with mainstream society and in all of these situations weather storms or all types can present immediate and unpredicted danger in a second of time. Taking advantage of the built in GPS positioning capability an integrated alert device of the object of this invention has the potential to alert users of dangerous situations and save lives of GPS users. As a power conserving feature the GPS receiver can have a software switch that turns off the alert receiver when its not needed.

### Dictionary Communication

In preferred embodiments radio transmissions to the disaster alert units utilize dictionary communication. A dictionary is installed in the memory of each disaster alert unit. The dictionary includes numbered sentences, phrases and words. Warning messages are prepared merely by combining numbers of the sentences, phrases and words. If words not in the dictionary are needed these words can be transmitted as digital information in a more standard format. By combining the numbered sentences, phrases and words that are in the dictionary with any needed words that are not in the dictionary the warning and instructions are prepared and transmitted. The processor in each disaster alert device formulates the warning and instructions and broadcasts them as instructed by the central station. Dictionaries can be made available in any language. This technique greatly reduces the amount of information that needs to be sent and in most cases simplifies and speeds up the time required to prepare the warning and instructions at the central station. Applicants propose a dictionary containing 65,536 (i.e. 2¹⁶) entries. Some examples of the entries are listed in Table I.

TABLE I
DICTIONARY

| | |
|---|---|
| 1. | This is an emergency warning from the Homeland Security |
| | Administration! |
| 2. | This is not a test! |
| 3. | There is a major forest fire threatening the location of |
| | this disaster alert device. |
| 4. | There is a high risk of a destructive tornado threatening |
| | the location of this disaster alert device. |
| 5. | There is a high risk of a tsunami threatening the location |
| | of this disaster alert device. |
| 6. | There is a high risk of a destructive flood threatening the |
| | location of this disaster alert device. |
| 7. | All persons present at this location are instructed to |
| | evacuate immediately. |
| 8. | All persons present are instructed to proceed to a high |
| | wind protected shelter immediately. |
| 9. | All persons present at this location are instructed to |
| | evacuate to high ground immediately. |
| 10. | a |
| 11. | able |
| 12. | about |
| 13. | above |
| * | |
| * | |
| * | |
| 65,536. | zoo |

The emergency message suggested in the section above entitled “Disaster Example” could thus be shortened to only four numbers: 1, 2, 3 and 9. English speaking families would hear the message in English and Spanish speaking families would hear it in Spanish since each disaster alert device would be provided with dictionaries in the appropriate language.

The dictionary may include a large number of words (such as the a-words listed in Table I) so that these words may be transmitted by numbers. (These a-words came from a list of the 1000 most common words in English.) Transmission of letters of words typically requires 8 bits per letter, whereas transmission of numbers (between 0 and 65,563) requires 16 bits. Therefore, for a four letter word like “able” or “fire”, transmitting its dictionary number would require 16 bits compared to 32 bits to transmit the four letters. The longer the word, phrase or sentence the more we save by transmitting dictionary numbers. We can also have numbers to represent tones such as the tones of piano keys.

### An Implementation Plan

The following implementation plan tries to take a reasonable path that provides the best compromise between the competing objectives of the system. First Applicants describe two low-level message types, which they propose to implement for disaster alert message transmission. The first type, called center-band or in-band, provides an easy and inexpensive way to transmit the messages without any required changes or upgrades to the NWS/NWR transmitters or feed hardware. The second, called hybrid or digital sideband, requires some moderate upgrades of the hardware feeding the NWS transmitters, but provides a more efficient and robust method of message transmission. Finally, Applicants describe a plan for rolling out the service.

### Message Types

### Center-Band (In-Band) Messages

The center-band message type is proposed as a means of transmitting messages that are compatible with all currently operating NWS/NWR stations without modification of any existing RF transmitters and office-to-transmitter feeds. This message type closely resembles the SAME (Specific Area Message Encoding) messages currently supported by NWS/NWR, but is much more specific. The message of the present invention is initiated with a synchronization signal followed by a digital header transmitted using audio frequency shift keying (ASFK). This header is similar to the message header for the SAME protocol. The messages could use the same tones used by the SAME broadcasts or could use other tones compatible with the transmission equipment. Unlike the SAME message header, the message header would need to include the location information defining the emergency region in terms of latitude and longitude. After the message header is transmitted the body of the message follows. A digital epilogue follows the body of the messages indicating the message is complete.

Several possibilities exist for transmitting the body of the message. Three of the best of these possibilities are described below:
1. Encode the message digitally and transmit it using the same AFSK technique used to transmit the message header.
2. Encode the message digitally and transmit it using another form of signaling such as Gaussian Frequency Shift Keying (GFSK).
3. Modulate the message with analog FM audio. This is the technique used in broadcasting the SAME messages.

The choice of which of these methods to use has still not been finalized.

The advantages and disadvantages of the center-band messages as we have defined them are discussed briefly below.
Advantages:
   Requires no modifications to any existing NWS/NWR transmitters and transmitter feeds.
Disadvantages:
   AFSK messages interrupt normal audio broadcasts of NWS/NWR
   GFSK messages do not require complete interruption of normal audio broadcasts but do cause noticeable impairments to these broadcasts
   Bit rate of AFSK is relatively low and therefore messages take relatively long to deliver
   The bit rate of GFSK is higher than that of AFSK but is still limited by the narrow center-band width and by the impairments of the transmitter feed lines.
   Because of low bit rate, the time required to send multiple messages in an emergency situation that requires different messages be sent to different regions within one transmitter's range will take a relatively long time
   AFSK does not make efficient use of RF bandwidth—it takes more Hz/(bit/sec) to transmit using AFSK than other digital techniques
   AFSK is not as robust and reliable as other digital modulation techniques. The noise-per-bit of AFSK modulation is relatively high for a given signal strength.
   Since the transmission of the message requires the interruption of audio broadcasts, and the transmission of modem-like tones that will be audible with the traditional audio weather radio receivers, the broadcast of periodic sync and timing signals at intervals of magnitude on the order of a minute or two will not be possible. The broadcast of these periodic signals enable, long-battery-life receivers to be engineered by allowing the receiver to be powered off for the majority of time. Without these signals, battery lifetime will be limited and a disaster alert unit powered exclusively by battery for extended periods of many months is not possible.

### Hybrid (Digital Sideband) Messages

The digital sideband message type is proposed as an alternative to ameliorate some of the disadvantages of the center-band technique described above. In practice it has one major disadvantage: it requires upgrading the NWS/NWR transmitters and the feeds for these transmitters. However, it does not suffer from the disadvantages of the center-band messages. In addition the upgraded transmitters and broadcasting infrastructure will enable the NWS/NWR to provide new digital services in addition to the broadcasts when and if they desire.

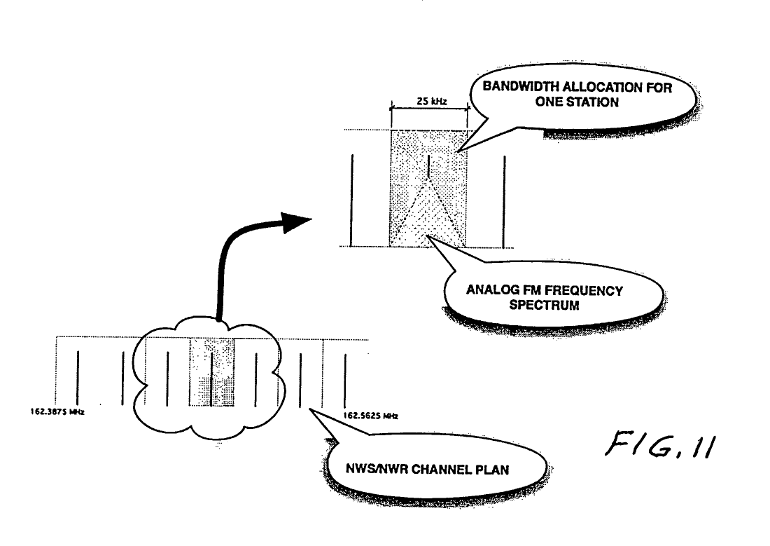

FIG. 11 shows a schematic representation of the RF bandwidth usage of a typical NWS/NWR audio broadcast. The separation between center frequencies of the 7 channels comprising the licensed bandwidth of network is 25 kHz. The maximum modulation is ±5 kHz for both audio and ASFK signals. With these parameters there is very little gap between adjacent channels of the spectrum. Therefore there are no significant buffer sidebands outside the analog broadcast but within the 25 kHz of the assigned spectrum. Due to this channel plan the hybrid digital LSDAD messages cannot be broadcast easily in the assigned 25 kHz of the local channel but can be broadcast in RF bandwidth outside this 25 kHz but within the total 175 kHz licensed to the NWS/NWR network.

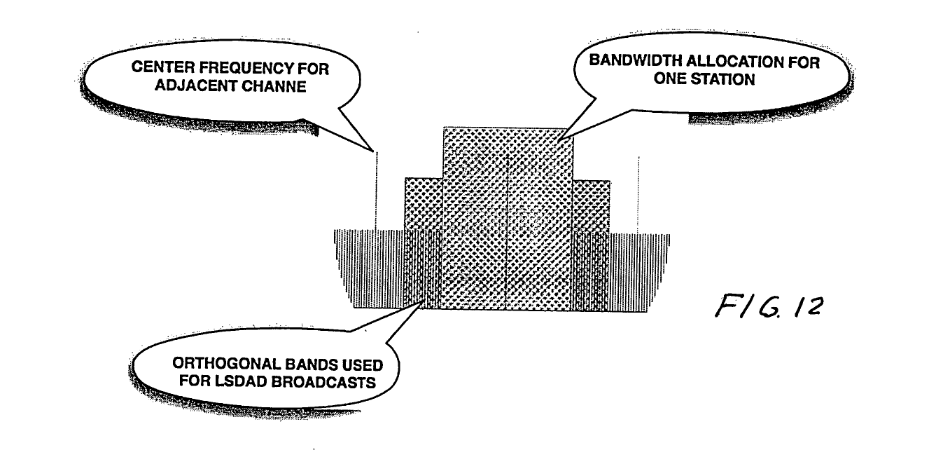

FIG. 12 shows the frequency utilization for one possible implementation of the hybrid message transmission. The bandwidth outside the central 25 kHz band allocated to the analog audio of the local station are divided up into small channels of approximately 200-300Hz that are mathematically orthogonal so that each band does not interfere with its neighboring channels. This form of bandwidth segmentation is commonly called orthogonal frequency division multiplexing (OFDM) and a form of it is used in broadcast radio where it is called HD-Radio and in Wi-Fi wireless networking systems. Interference with the analog audio broadcasts of neighboring stations can be avoided by not transmitting in their allotted 25 kHz spectrum. And interference with the digital messages of neighboring stations can be achieved by avoiding the OFDM channels used by neighboring stations or by the methods used in other wireless applications—like frequency hopping.

Like the expanded portion of FIG. 11, a small portion of the entire licensed bandwidth is illustrated. The horizontal axis shows RF frequency. The red shaded area indicates the central 25 kHz of a local channel and is reserved for the legacy audio broadcasts. The rest of the entire 125 kHz allocated for the NWS/NWR network is divided up into orthogonal channels approximate 200-300 Hz wide—the divisions of these OFDM bands are the comb structure depicted by the black vertical lines. In this case, several of these orthogonal bands in the blue shaded regions on each side of the central audio broadcast are reserved for LSDAD timing, synchronization, control, and messages. The other OFDM channels can be used for future services provided by the NWS/NWR.

OFDM is not the only method of utilizing the extra bandwidth in the NWS/NWR spectrum without interfering with neighboring stations. For example, a code division multiple access (CDMA) scheme could be used. Where other systems have used OFDM, CDMA may ultimately be the best for the NWS network due to the current frequency reuse plan adopted used by the NWS. CDMA may allow better use of the NWS spectrum for broadcasting of different messages by nearby transmitters.

Upgrading the NWS/NWR hardware for transmission of the LSDAD digital messages means that the spectrum that is not used by the local audio broadcasts can be utilized for other services in addition to the LSDAD messages. During non-emergency operation the LSDAD systems will use little of the newly available extra bandwidth available to the transmitters and transmitter feeds. Even in emergency situations LSDAD broadcasts are likely to not require the entire 125 kHz of bandwidth assigned to the NWS/NWR. So, this unused bandwidth could be used to provide additional services. For example, the text equivalent of the standard NWS/NWR audio weather radio broadcasts could be transmitted for use by the deaf Similarly, other data and digital audio information may also be broadcast

### Service Rollout

Assuming that the low-level message types adopted for the transmissions are similar to the ones described above, one particular plan for rolling out the services of the present invention on the NWS/NWR network suggests itself as a means of providing coverage as quickly and efficiently as possible. In this scenario, all deployed disaster alert units would be capable of receiving and decoding both the center-band and sideband transmissions. Internal circuitry within each individual unit would search for sideband transmissions within the NWS/NWR band. If such a signal with sufficient signal to noise ratio was found, the unit would rely on it for reception of the warning messages. If no sideband messages were available the unit would continually monitor the strongest center-band NWS/NWR channel looking for an AFSK emergency message.

While the ability to receive center-band search for a valid sideband message would require a slightly more complicated unit, it has the advantage being able to provide some form of message service from every NWS/NWR transmitter immediately without requiring the entire NWS/NWR service to be upgraded immediately. The NWS would be able to phase the upgrade of transmitters, concentrating first on stations that are more important and upgrading less important stations as resources become available. For example, stations that service particularly dense population areas or service areas with particularly high risk could be upgraded to sideband transmission as soon as the disaster alert units become available. Other stations that service less densely populated areas, or areas with lower risk, could provide center band-only transmission at the start.

As stations are upgraded to sideband transmission, the transition by the users of the disaster alert units would be transparent. Whenever a unit detects the availability of suitable sideband transmissions it will automatically switch to using these as the source of its broadcasts. Since all units will be capable of receiving sideband transmissions the NWS/NWR stations may even cease center-band transmission when sideband transmission is implemented. This frees the center-band frequencies completely from providing disaster alert services and allows legacy audio NWS/NWR services to continue uninterrupted.

While the present invention has been described in terms of specific preferred embodiments and the prototype, the reader should understand that many changes and modifications can be made within the scope of the invention. For example many encryption techniques can be utilized to assure the system is not improperly manipulated to produce false alarms. Central stations may also designate regions to which alerts are transmitted by using designations other than latitude and longitude, such as street addresses or area codes. Also, the central station could also broadcast the location of a hazard and a warning radius, and the alert devices could be programmed to decide whether or not an alert should be provided. Preferred embodiments will operate with wall power at 110 Volts AC rectified down to 9 volts with a 9 volt NiCad battery backup. For example, the alarm siren could be set up to respond selectively (and differently) to independent alarms from the following organizations:
1. Local Household Fire alarm;
2. Local Household Intruder alarm;
3. National Weather Service for severe weather or tornado;
4. Local Fire/Police for public emergencies or advisories;
5. Emergency Broadcast System;
6. State Government alerts;
7. FEMA;
8. Tsunami advisory organizations;
9. Dept of Homeland Defense;
10. Other Authorized and selected agencies.

The SAME system described in the Background Section has developed 62 codes for that many emergency situation and these codes could be incorporated into the system of the present invention. Each originating agency or system would have its own private key for encryption of the activation signal (which is kept secret by that organization). Each warning receiver in every home or business would have the same set of decryption keys for the organizations (the public keys). The receiver would only decrypt an alarm signal (using the public key) if it were encrypted using a secret private key. It would be possible to reprogram the decryption keys on an open channel, in the event of compromise of one of the encryption keys. Installation of the system may include (automatically over-the-air) initialization of the public decryption keys. Upon the occurrence of a public emergency or hazard, the central office would switch its transmission to the encrypted signal from the originating agency, which would then be decrypted at the warning receiver units in people's homes and the appropriate alarm siren, text, or voice message generated. In cities with tall buildings alert warning devices could be programmed with altitude so that warnings could be directed devices located on specific floors of the buildings at specific locations. In a 911 situation people in the top floors of all tall buildings within appropriate regions could be evacuated as soon as Homeland Security learns that a airline plane has been hijacked. Additional features can be added to the disaster warning devices such as those shown in FIG. 3. A chemical sensor or a biological hazard sensor could be added. So the scope of the invention should be determined by the appended claims and their legal equivalence.

What is claimed is:

1. A disaster alert system comprising
A) at least one central station for transmitting disaster alert information by radio directed at disaster alert devices at use locations in specific at-risk regions defined by latitude and longitude,
B) a plurality of disaster alert devices, each device adapted for use at a use location in a disaster alert system, with each disaster alert device comprising:
1) a radio receiver,
2) an audio unit for alerting persons located at the use location to the precise nature of a disaster, and
3) a processor comprising a memory unit with latitude and longitude of the use location stored therein, wherein said processor is:
a) programmed to monitor radio transmissions from a central station for disaster alerts directed to all disaster alert devices located within an at-risk region defined by latitude and longitude information,
b) programmed to compare the latitude and longitude information transmitted by the central station with the latitude and longitude information stored in its memory unit to determine if a message is directed to the disaster alert unit, and
c) programmed to provide a voice warning via said audio unit of the nature of potential or actual risks to people at the use location based on information received by the disaster alert device from the central station when and only when the disaster alert device is among the disaster alert devices to which a transmission from the central station is directed.

2. The disaster alert system as in claim 1 wherein a plurality of the disaster alert devices are battery powered.

3. The disaster alert system as in claim 2 wherein a plurality of the battery powered disaster alert devices are programmed with a sleep mode to conserve battery power.

4. The disaster alert system as in claim 1 wherein said central station comprises a radio transmit system programmed to transmit disaster warnings in a transmission having a header portion and a message portion wherein the header portion of the transmission contains latitude and longitude information defining at least one potential at-risk region.

5. The disaster alert system as in claim 4 wherein the potential at-risk region is defined nominally to a first precision in the header portion and the radio transmit system is further programmed to transmit additional latitude and longitude information in the message portion defining precise at-risk regions with additional latitude and longitude information at a second precision that is more precise than the first precision.

6. The disaster alert system as in claim 5 wherein the first second precision defines latitude and longitude to a precision of 0.1 second of arc or smaller.

7. The disaster alert system as in claim 4 wherein the latitude and longitude information in the header is provided to a precision of 1.0 second of arc or smaller.

8. The disaster alert system as in claim 4 wherein the latitude and longitude information in the header is provided to a precision of 0.5 second of arc or smaller.

9. The disaster alert system as in claim 4 wherein the latitude and longitude information in the header is provided to a precision of 0.1 second of arc or smaller.

10. The device as in claim 1 and said processor is programmed with decryption software for decoding encrypted transmissions from the central stations.

11. The device as in claim 1 wherein said audio unit is a voice synthesizer.

12. The device as in claim 1 wherein said audio unit comprises a speaker.

13. The device as in claim 1 wherein said audio unit is a digital recording device.

14. The device as in claim 1 wherein said processor is programmed at the time of sale or installation with information identifying the use location of the device.

15. The device as in claim 14 wherein the latitude and longitude information is obtained from the Internet.

16. The device as in claim 14 wherein the latitude and longitude information is obtained from a GPS device.

17. A disaster alert device adapted for use at a use location in a disaster alert system, said disaster alert device comprising:
1) a radio receiver,
2) an audio unit for alerting persons located at the use location to the precise nature of a disaster, and
3) a processor comprising a memory unit with latitude and longitude of the use location stored therein, wherein said processor is:
a) programmed to monitor radio transmissions from a central station for disaster alerts directed to all disaster alert devices located within an at-risk region defined by latitude and longitude information,
b) programmed to compare the latitude and longitude information transmitted by the central station with the latitude and longitude information stored in its memory unit to determine if a message is directed to the disaster alert unit, and
c) programmed to provide a voice warning via said audio unit of the nature of potential or actual risks to people at the use location based on information received by the disaster alert device from the central station when and only when the disaster alert device is among the disaster alert devices to which a transmission from the central station is directed.

18. The disaster alert device as in claim 17 wherein the disaster alert device is battery powered.

19. The disaster alert device as in claim 18 wherein the devices is programmed with a sleep mode to conserve battery power.

20. The device as in claim 17 and said device is programmed with decryption software for decoding encrypted transmissions from the central stations.

21. The device as in claim 17 wherein said audio unit is a voice synthesizer.

22. The device as in claim 17 wherein said audio unit comprises a speaker.

23. The device as in claim 17 wherein said processor is programmed at the time of sale or installation with information identifying the use location of the device.

24. The system as in claim 1 wherein said plurality of disaster alert devices also comprise a transmitter,

25. The system as in claim 24 wherein said transmitter is adapted to transmit information to emergency personnel.

26. The system as in claim 24 wherein said transmitter is adapted to transmit information to nearby electronic equipment.

27. A method of operating a disaster alert system comprising the steps of:
A) establishing at least one central station for transmitting disaster alert information by radio directed at disaster alert devices at use locations in specific at-risk regions defined by latitude and longitude,
B) distributing to users a plurality of disaster alert devices, each device adapted for use at a use location in a disaster alert system, with each disaster alert device comprising:
1) a radio receiver,
2) an audio unit for alerting persons located at the use location to the precise nature of a disaster, and
3) a processor comprising a memory unit with latitude and longitude of the use location stored therein, wherein said processor is:
a) programmed to monitor radio transmissions from a central station for disaster alerts directed to all disaster alert devices located within an at-risk region defined by latitude and longitude information,
b) programmed to compare the latitude and longitude information transmitted by the central station with the latitude and longitude information stored in its memory unit to determine if a message is directed to the disaster alert unit, and
c) programmed to provide a voice warning via said audio unit of the nature of potential or actual risks to people at the use location based on information received by the disaster alert device from the central station when and only when the disaster alert device is among the disaster alert devices to which a transmission from the central station is directed;
C) having personnel at said at least one central station respond to notification of potential disaster in a region:
1) identify an at-risk region encompassing the region of potential disaster,
2) prepare a warning and instructions for persons in said at-risk region and
3) transmit a radio message defining the at-risk region in terms of latitude and longitude;
wherein persons in said at-risk region are warned by voice warnings from said disaster alert devices of the potential disaster and provided instruction regarding how to deal with the potential disaster.

28. The method as in claim 27 and further comprising a step of having mobile phone companies transmit warning messages to mobile phones located is said at-risk regions.

29. The method as in claim 27 and further comprising a step of having Internet providers transmit warning messages to computers located is said at-risk regions.

30. The method as in claim 27 and further comprising a step of having cable television providers transmit warning messages to television sets located is said at-risk regions.

31. The method as in claim 27 and further comprising a step of having companies providing wired telephone service transmit warning messages to wired telephones located is said at-risk regions.

32. The method as in claim 27 and further comprising a step of utilizing commercial television transmitters to re-transmit at-risk messages to disaster alert devices.

33. The method as in claim 27 and further comprising a step of utilizing commercial radio transmitters to re-transmit at-risk messages to disaster alert devices.
